(19) United States
(12) Patent Application Publication
(10) Pub. No.: US 2014/0112496 A1
(43) Pub. Date: Apr. 24, 2014

(54) MICROPHONE PLACEMENT FOR NOISE CANCELLATION IN VEHICLES

(71) Applicants: Carlo Murgia, Sunnyvale, CA (US); Alfredo Aguilar, Sunnyvale, CA (US); Scott Isabel, Sunnyvale, CA (US); Jean Laroche, Santa Cruz, CA (US)

(72) Inventors: Carlo Murgia, Sunnyvale, CA (US); Alfredo Aguilar, Sunnyvale, CA (US); Scott Isabel, Sunnyvale, CA (US); Jean Laroche, Santa Cruz, CA (US)

(21) Appl. No.: 14/058,059

(22) Filed: Oct. 18, 2013

Related U.S. Application Data
(60) Provisional application No. 61/716,042, filed on Oct. 19, 2012.
(60) Provisional application No. 61/716,025, filed on Oct. 19, 2012.
(60) Provisional application No. 61/716,037, filed on Oct. 19, 2012.
(60) Provisional application No. 61/716,337, filed on Oct. 19, 2012.
(60) Provisional application No. 61/716,399, filed on Oct. 19, 2012.

(51) Int. Cl. G10L 21/02

(52) U.S. Cl. CPC G10L 21/0205
USPC 381/92

(57) ABSTRACT

Systems and methods for processing acoustic signals in vehicles are provided. An example system comprises one or more microphones and a voice monitoring device. The voice monitoring device can receive, via the one or more microphones, an acoustic signal and suppress noise in the acoustic signal to obtain a clean speech component. The obtained clean speech component can be provided to one or more vehicle systems. In some embodiments, two microphones selected from the one or more microphones can be positioned on an inner side of a roof of the vehicle, above a windshield, in front of a driver's seat, and directed towards a driver. The two microphones can be equidistant with respect to a symmetry plane of the driver's seat.

### CROSS-REFERENCE TO RELATED APPLICATIONS

The present application claims the benefit of the U.S. provisional application No. 61/716,042, filed on Oct. 19, 2012, U.S. provisional application No. 61/716,025, filed on Oct. 19, 2012, U.S. provisional application No. 61/716,037, filed on Oct. 19, 2012, U.S. provisional application No. 61/716,337, filed on Oct. 19, 2012, and U.S. provisional application No. 61/716,399, filed on Oct. 19, 2012. The subject matter of the aforementioned applications is incorporated herein by reference for all purposes to the extent that such subject matter is not inconsistent herewith or limiting hereof.

### FIELD

The present application relates generally to acoustic signal processing and more specifically to microphone placement for noise cancelation for acoustic signals inside vehicles.

### BACKGROUND

Vehicles include mobile machines to transport passengers and cargo. Vehicles may operate on land, sea, air, and in space. Vehicles, for example, may include cars/automobiles, trucks, trains, monorails, ships, airplanes, gliders, helicopters, and spacecraft. Vehicle operators (e.g., driver and pilot) may occupy specific areas of the vehicle, for example, a driver's seat, cockpit, bridge, and the like. Passengers and/or cargo may occupy other areas of the vehicle, for example, passenger's seat, back seat, trunk, passenger car, freight cars, cargo hold, and the like.

Vehicles can provide enclosed acoustic environments. For example, a car, cockpit, and bridge may have windows to offer a wide angle of view. The floors, ceilings/roofs, console, and upholstery of the car, cockpit, bridge, and so forth are comprised of certain materials.

Vehicles can experience certain noises arising from operation and the environments in which they operate. The noise experienced within a vehicle may interfere with the hearing, sensing, or detecting of spoken communications (e.g., speech). For example, a person inside a vehicle communicating with an audio device (e.g., mobile telephone connected via Bluetooth) may not be able to understand or be understood by the other party. By way of further example, voice commands directed to devices within the vehicle (e.g., to the navigation system, and stereo) or outside the vehicle (e.g., cloud computing) may not be properly understood. Moreover, there is generally a limited number of places in which a microphone can be situated in a vehicle.

Furthermore, there may be more than one person in the vehicle who may wish to communicate over the audio device and/or with other occupants of the vehicle. Known vehicles generally have microphones directed only toward the occupants of the front seats (e.g., driver).

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

According to example embodiments, a system for processing an acoustic signal in a vehicle may comprise one or more microphones and a voice monitoring device. The voice monitoring device may receive, via the one or more microphones, the acoustic signal and suppress the acoustic signal to obtain a clean speech component, also referred to variously herein as a clean voice component. The clean speech component may be further provided to a communications system, an entertainment system, a climate control system, a navigation system, an engine, and the like.

In some embodiments, two microphones from the one or more microphones may be placed on an inner side of a roof of the vehicle, above the windshield, in front of the driver's seat, and directed towards the driver. The microphones may be equally spaced relative to a symmetry plane of the driver's seat. In other embodiments, the microphones may be placed on a rear view mirror and directed towards a driver's seat. In certain embodiments, the microphones may be disposed in a driver's and/or a passenger's sun visor. In some embodiments, the microphones may be directed towards detecting speech from a certain speaker, driver, or passenger. In certain embodiments, part of the microphones may be directed to detecting noise associated with certain devices inside the automobile.

In some embodiments, the clean speech component may be provided to a vehicle communication system. In certain embodiments, the communication system may provide the clean speech component to a device located outside the automobile. In other embodiments, the communication system may provide the clean speech component to occupants of the automobile, allowing them to communicate in a noisy acoustic environment. In some embodiments, the communication system may suppress speech signals originating from a source outside a pre-determined area in the automobile.

### BRIEF DESCRIPTION OF THE DRAWINGS

Embodiments are illustrated by way of example and not limitation in the figures of the accompanying drawings, in which like references indicate similar elements and in which:

FIG. 1 is a system for processing an acoustic signal in automobiles, according to an example embodiment.

FIG. 2 is a block diagram of a voice monitoring device, according to an example embodiment.

FIG. 3 is a block diagram of an audio processing system performing a noise cancellation, according to an example embodiment.

FIG. 4A shows placement of a pair of broadside microphones on a roof of a vehicle, according to an example embodiment.

FIG. 4B shows a schematic top view of microphone placement illustrated in FIG. 4A, according to an example embodiment.

FIG. 5A shows a placement of pair of front/back microphones on a roof of a vehicle, according to an example embodiment.

FIG. 5B shows a schematic top view of microphone placement illustrated in FIG. 5A, according to an example embodiment.

FIG. 6A shows a placement of a pair of front/back microphones on a rear view mirror of a vehicle, according to an example embodiment.

FIG. 6B shows a schematic top view of microphone placement illustrated in FIG. 6A, according to an example embodiment.

FIG. 7 is a flow chart illustrating steps of example method for placing microphones in a vehicle, according to an example embodiment.

FIG. 8 is an example of a computing system implementing a method for placing microphones in a vehicle.

### DETAILED DESCRIPTION

The present disclosure provides example systems and methods for processing an acoustic signal in automobiles. Embodiments of the present disclosure may be practiced in automobiles or other vehicles. Embodiments of the present disclosure may be used to extract a clean speech (voice) component from the acoustic signal overlapping with noise (e.g., due to operation of automobile, etc.). A clean voice component may be extracted from a noisy acoustic signal by a combination of noise suppression processing and placement of microphones inside the automobile.

According to an example embodiment, a system for processing an acoustic signal in a vehicle may comprise one or more microphones and a voice monitoring device. The voice monitoring may be configured receive, via the microphones, the acoustic signal and suppress noise in the acoustic signal to obtain a clean voice component. The obtained clean voice component may be provided to one or more vehicle systems. In some embodiments, two microphones may be placed on an inner side of a roof of the automobile, above the windshield, in front of the driver's seat, and may be directed towards a driver. The microphones may be equally spaced relative to a symmetry plane of the driver's seat.

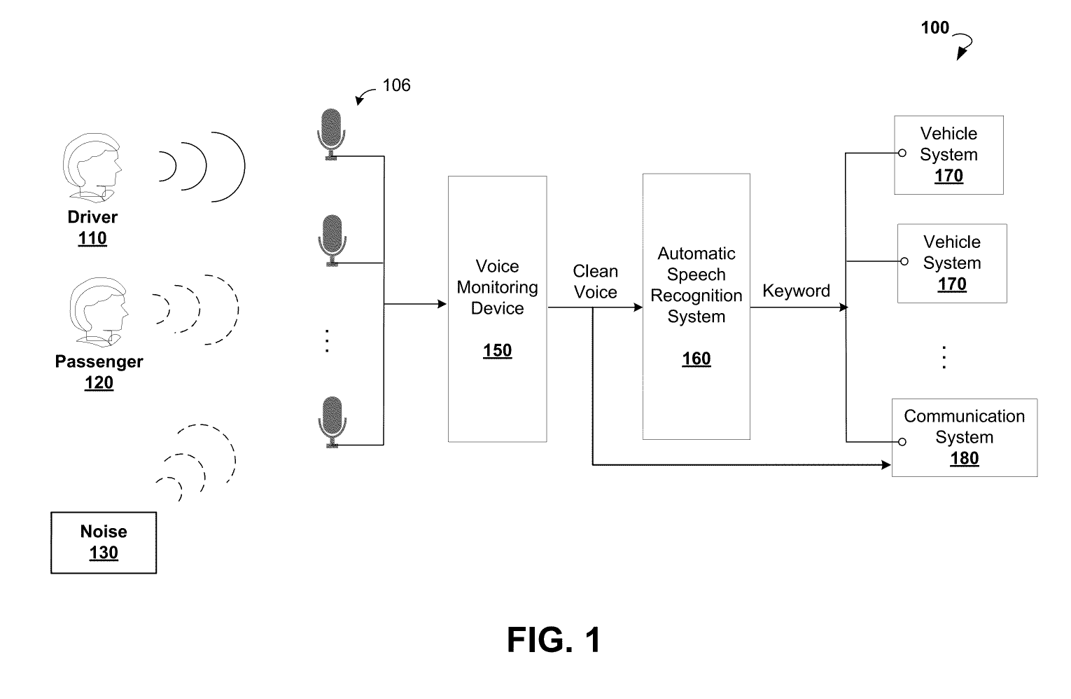

Referring now to FIG. 1, an example system 100 for processing an acoustic signal in a vehicle is shown. In some embodiments, the system 100 may comprise, microphones 106, a voice monitoring device 150, an automatic speech recognition system 160, and one or more vehicle systems 170. The system 100 may include more or fewer components than illustrated in FIG. 1, and the functionality of modules may be combined or expanded into fewer or additional modules. Thus, in certain embodiments, the system 100 may comprise several voice monitoring devices 150 and several automatic speech recognition systems 160. In other embodiments, the electronic voice monitoring device 150 or automatic speech recognition system 160 may be incorporated in vehicle system 170.

In some embodiments, microphones 106 may be used to detect both spoken communications, for example, voice commands from the driver 110 or the passenger 120 or other operator and the noise 130 experienced inside the vehicle. In some embodiments of the system for keyword voice activation, some microphones may be used mainly to detect speech and other microphones may be used mainly to detect noise. In other embodiments, some microphones may be used to detect both noise and speech.

Acoustic signals detected by the microphones 106 may be used to separate speech from the noise by the voice monitoring device 150. Strategic placement of the microphones may substantially contribute to the quality of noise reduction. High quality noise reduction, for example, may produce clean speech that is very close to the original speech. Microphones directed towards detecting speech from a certain speaker, driver, or passenger, may be disposed in relative close proximity to the speaker. In some embodiments, two or more microphones may be directed towards the speaker. In further embodiments, two or more microphones may be positioned in a relatively close proximity of each other.

Microphones may also be directed to detecting various types of noises, for example, noises generated by a road, a track, a tire/wheel, a fan, a wiper blade, an engine, exhaust system, an entertainment system, a communications system, competing speakers, wind, rain, waves, other vehicles, exterior, and other noises. In some embodiments, microphones used to detect noise may be disposed for more accurate detection of one or more specific noise components/sources. In further embodiments, microphones directed to detecting noise may be sufficiently separated from microphones use to detect speech for better noise identification and subtraction.

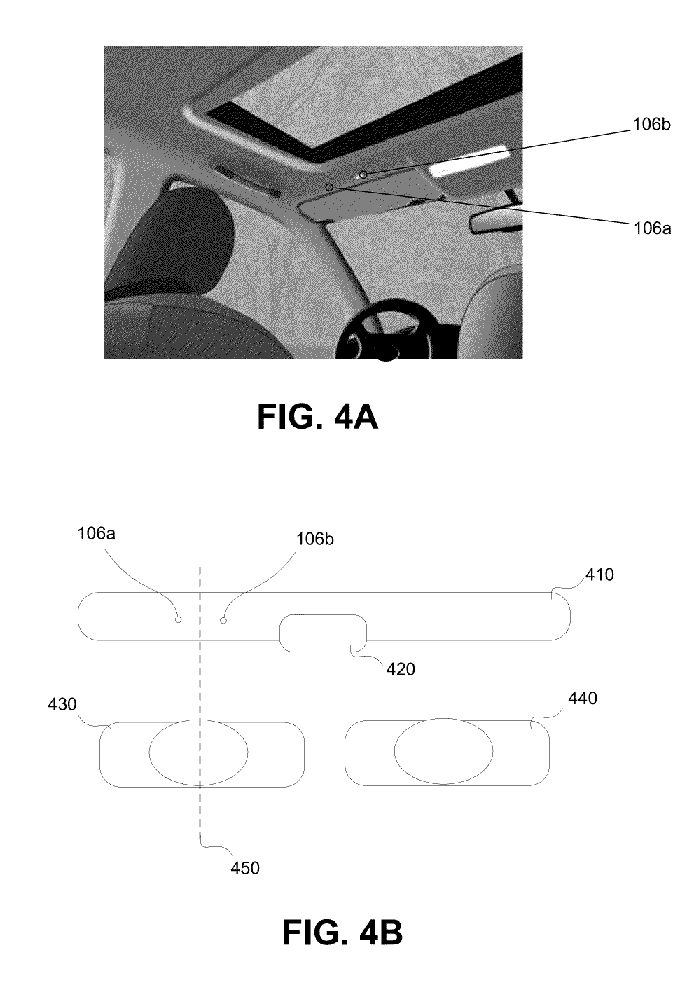

Microphones may be placed in various locations, such as for example, in the center of the dashboard, center console, roof between the driver and a front passenger, rear view mirror on the left and/or right side, left side of the windshield (e.g., for the driver), right side of the windshield (e.g., for the front passenger), behind the steering wheel (e.g., for the driver), in or around a glove compartment (e.g., for front passenger), headrests (e.g., in left and right seats for rear passengers), and the like for detecting speech and/or noise. Some examples of microphone placement in a vehicle are disclosed below with reference to FIGS. 4A-6B.

In some embodiments of the system 100, one or more voice monitoring devices 160 may be configured to monitor speech acoustic signals continuously from one or more microphones 106 and to remove the noise from the detected acoustic signals. In other embodiments one or more voice monitoring devices 150 may be activated selectively based on input, for example, from a voice activity detector.

Clean speech obtained via the voice monitoring device 150 may be provided to an automatic speech recognition system (ASR). The ASR system may provide recognized speech, for example, a recognized voice command, to one or more vehicle systems 170. The vehicle systems 170 may include a communications system 180, an entertainment system, a climate control system, a navigation system, an engine, and the like. In some embodiments, the ASR system 160 may be separate from and communicatively coupled with the one or more vehicle systems 170. In other embodiments, the ASR system 160 may be at least partially incorporated into the one or more vehicle systems. In some embodiments, clean speech obtained by the voice monitoring unit may be provided directly to communication system 180.

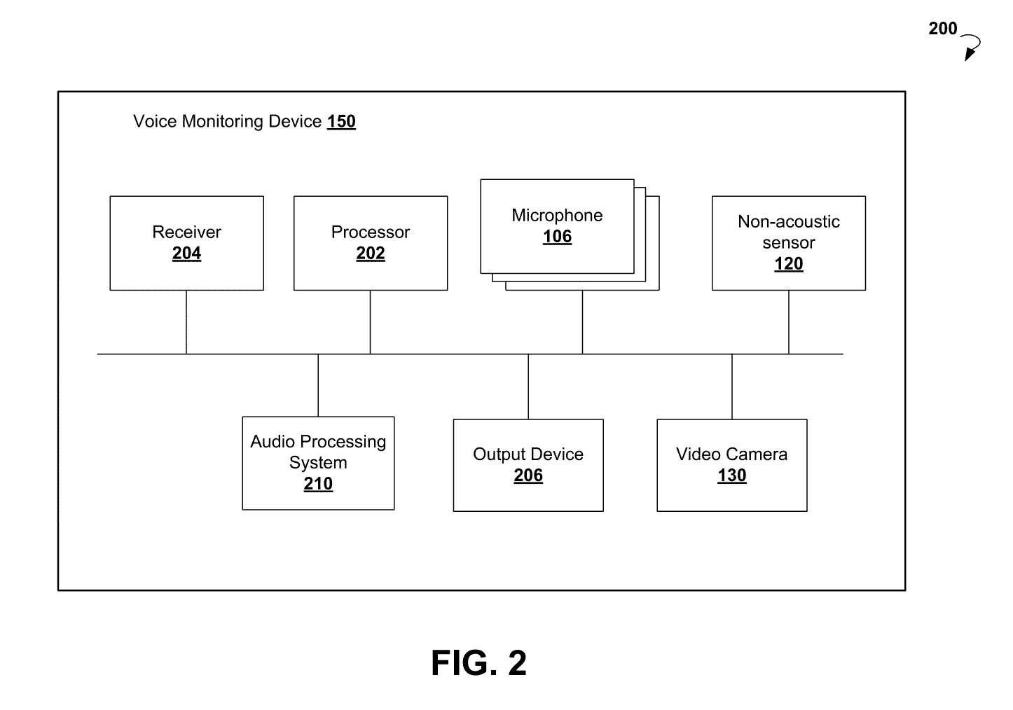

FIG. 2 is a block diagram of an example voice monitoring device 150. In example embodiments, the voice monitoring device 150 (also shown in FIG. 1) may include a processor 202, a receiver 204, one or more microphones 106 (also shown in FIG. 1), an audio processing system 210, an optional non-acoustic sensor 120, an optional video camera 130, and an output device 206. In operation, the voice monitoring device 150 may comprise additional or different components. Similarly, voice monitoring device 150 may comprise fewer components that perform functions similar or equivalent to those depicted in FIG. 2.

Still referring to FIG. 2, the processor 202 may include hardware and/or software, which may execute computer programs stored in a memory (not shown in FIG. 2). The processor 202 may use floating point operations, complex operations, and other operations, including noise reduction or suppression in received acoustic signal.

The optional non-acoustic sensor 120 may measure a spatial position of a sound source, such as the mouth of a main talker (also referred to as “Mouth Reference Point” or MRP). The optional non-acoustic sensor 120 may also measure a distance between the one or more microphones 106 (or voice monitoring device 104) and a sound source. The optional non-acoustic sensor 120 may also measure relative position of the one or more microphones 106 (or electronic device 104) and a sound source. In either case, the optional non-acoustic sensor 120 generates positional information, which may be provided to the processor 202 or stored in a memory (not shown).

The video camera 130 may be configured to capture still or motion images of an environment from which the acoustic signal is captured. The images captured by the video camera 130 may include pictures taken within the visible light spectrum or within a non-visible light spectrum such as the infrared light spectrum (also referred to as “thermal vision” images). The video camera 130 may generate a video signal of the environment, which may include one or more sound sources (e.g., talkers) and optionally one or more noise sources (e.g., other talkers and operating machines). The video signal may be transmitted to the processor 202 for storing in a memory (not shown) or processing to determine relative position of one or more sound sources.

The audio processing system 210 may be configured to receive acoustic signals from an acoustic source via the one or more microphones 106 and process the acoustic signal components. The microphones 106 (if multiple microphones 106 are utilized) may be spaced a distance apart from each other such that acoustic waves impinging on the device from certain directions exhibit different energy levels at the two or more microphones. After reception by the microphones 106, the acoustic signals may be converted into electric signals. These electric signals may themselves be converted by an analog-to-digital converter (not shown) into digital signals for processing in accordance with some embodiments.

In some embodiments, the microphones 106 may be omni-directional microphones closely spaced (e.g., 1-2 cm apart), and a beamforming technique may be used to simulate a forward-facing and a backward-facing directional microphone response. Alternatively embodiments may utilize other forms of microphones or acoustic sensors. A level difference may be obtained using the simulated forward-facing and the backward-facing directional microphone. According to various embodiments for microphone placements, the level difference between (at least) two microphones may be used to discriminate between speech and noise, for example, in the time-frequency domain, which can be used in noise and/or echo reduction. In other embodiments, the microphones 106 are directional microphones, which may be arranged in rows and oriented in various directions.

In certain embodiments, the acoustic signal may be provided to voice monitoring device 150 via receiver 204. For example, one or more microphones may be placed in a car key, a key fob, a watch, or other wearable remote device. The acoustic signal may be converted to an audio signal and transmitted to the voice monitoring device 150 via a radio channel, Bluetooth, infrared, or the like.

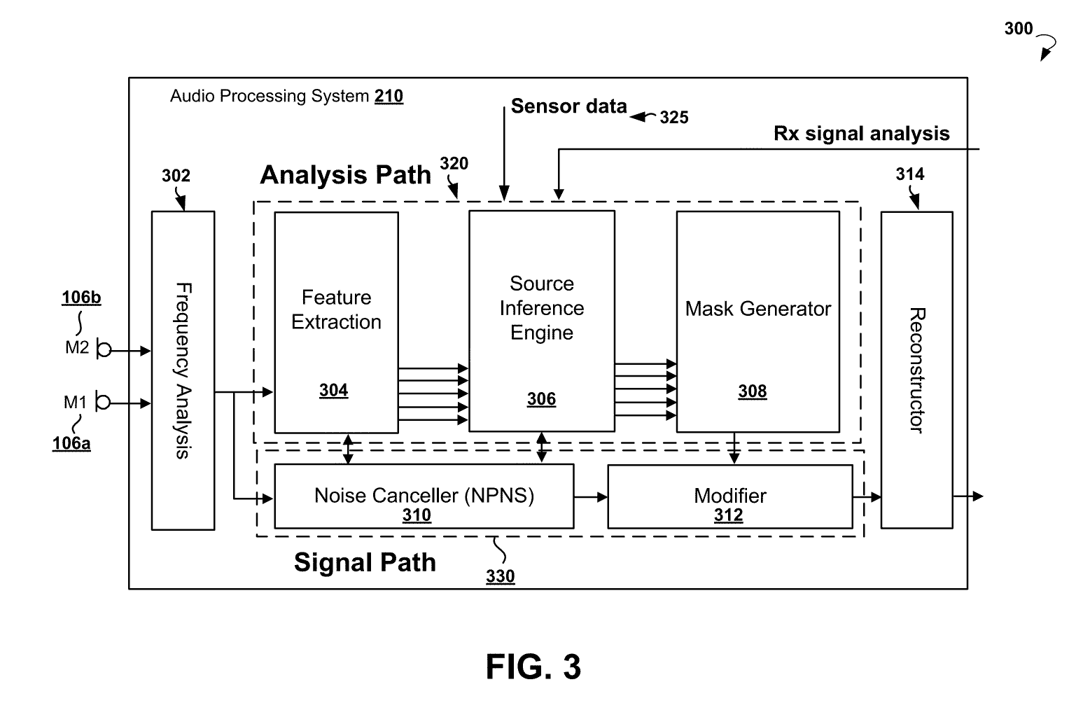

FIG. 3 is a block diagram of an example audio processing system 210. In example embodiments, the audio processing system 210 (also shown in FIG. 2) may be embodied within a memory device inside the voice monitoring device 150 (shown in FIG. 2). The audio processing system 210 may include a frequency analysis module 302, a feature extraction module 304, a source inference engine module 306, a mask generator module 308, a noise canceller (Null Processing Noise Subtraction or NPNS) module 310, a modifier module 312, and a reconstructor module 314. Descriptions of these modules are provided below.

The audio processing system 210 may include more or fewer components than illustrated in FIG. 3, and the functionality of modules may be combined or expanded into fewer or additional modules. Example lines of communications are illustrated between various modules of FIG. 3, and in other figures herein. The lines of communication are not intended to limit which modules are communicatively coupled with other modules, nor are they intended to limit the number of and type of signals between modules.

Data provided by non-acoustic sensor 120 (FIG. 2) may be used in audio processing system 210, for example, by analysis path sub-system 320. This is illustrated in FIG. 3 by sensor data 325, which may be provided by the non-acoustic sensor 120, leading into the analysis path sub-system 320.

In the audio processing system of FIG. 3, acoustic signals received from a primary microphone 106a and a secondary microphone 106b (in this example, two microphones 106 are shown for clarity, other number of microphones may be used) may be converted to electrical signals, and the electrical signals may be processed by frequency analysis module 302. In one embodiment, the frequency analysis module 302 may receive the acoustic signals and mimic the frequency analysis of the cochlea (e.g., cochlear domain) simulated by a filter bank. The frequency analysis module 302 may separate each of the primary and secondary acoustic signals into two or more frequency sub-band signals. A sub-band signal is the result of a filtering operation on an input signal, where the bandwidth of the filter is narrower than the bandwidth of the signal received by the frequency analysis module 302. Alternatively, other filters such as a short-time Fourier transform (STFT), sub-band filter banks, modulated complex lapped transforms, cochlear models, wavelets, and so forth can be used for the frequency analysis and synthesis.

Because most sounds (acoustic signals) are complex and include more than one frequency, a sub-band analysis of the acoustic signal may determine what individual frequencies are present in each sub-band of the complex acoustic signal during a frame (e.g. a predetermined period of time). For example, the duration of a frame may be 4 ms, 8 ms, or some other length of time. Some embodiments may not use frames at all. The frequency analysis module 302 may provide sub-band signals in a fast cochlea transform (FCT) domain as an output.

Frames of sub-band signals may be provided by frequency analysis module 302 to the analysis path sub-system 320 and to the signal path sub-system 330. The analysis path sub-system 320 may process a signal to identify signal features, distinguish between speech components and noise components of the sub-band signals, and generate a signal modifier. The signal path sub-system 330 may modify sub-band signals of the primary acoustic signal, e.g. by applying a modifier such as a multiplicative gain mask or a filter, or by using subtractive signal components generated in analysis path sub-system 320. The modification may reduce undesired components (i.e. noise) and preserve desired speech components (i.e. main speech) in the sub-band signals.

Noise suppression can use gain masks multiplied against a sub-band acoustic signal to suppress the energy levels of noise (i.e. undesired) components in the subband signals. This process may also be referred to as multiplicative noise suppression. In some embodiments, acoustic signals can be modified by other techniques, such as a filter. The energy level of a noise component may be reduced to less than a residual noise target level, which may be fixed or slowly vary over time. A residual noise target level may, for example, be defined as a level at which a noise component is no longer audible or perceptible, below a noise level of a microphone used to capture the acoustic signal, or below a noise gate of a component such as an internal Automatic Gain Control (AGC) noise gate or a baseband noise gate within a system used to perform the noise cancellation techniques described herein.

Still referring to FIG. 3, the signal path sub-system 330 within audio processing system 210 may include NPNS module 310 and modifier module 312. The NPNS module 310 may receive sub-band frame signals from frequency analysis module 302. The NPNS module 310 may subtract (e.g., cancel) an undesired component (i.e. noise) from one or more sub-band signals of the primary acoustic signal. As such, the NPNS module 310 may output sub-band estimates of noise components in the primary signal and sub-band estimates of speech components in the form of noise-subtracted sub-band signals.

The NPNS module 310 within signal path sub-system 330 may be implemented in a variety of ways. In some embodiments, the NPNS module 310 may be implemented with a single NPNS module. Alternatively, the NPNS module 310 may include two or more NPNS modules, which may be arranged for example, in a cascade fashion. The NPNS module 310 can provide noise cancellation for multi-microphone configurations, for example, based on a source location, by utilizing a subtractive algorithm. It can also provide echo cancellation. Since noise and echo cancellation can usually be achieved with little or no voice quality degradation, processing performed by the NPNS module 310 may result in an increased signal-to-noise-ratio (SNR) in the primary acoustic signal received by subsequent post-filtering and multiplicative stages, some of which are shown elsewhere in FIG. 3. The amount of noise cancellation performed may depend on the diffuseness of the noise source and the distance between microphones. Both of these can contribute towards the coherence of the noise between the microphones, with greater coherence resulting in better cancellation by the NPNS module.

An example of null processing noise subtraction performed in some embodiments by the NPNS module 310 is disclosed in U.S. Utility patent application Ser. No. 12/422,917, entitled “Adaptive Noise Cancellation,” filed Apr. 13, 2009, which is incorporated herein by reference.

Noise cancellation may be based on null processing, which may involve cancelling an undesired component in an acoustic signal by attenuating audio from a specific direction, while simultaneously preserving a desired component in an acoustic signal, e.g. from a target location such as a main talker. The desired audio signal may include a speech signal. Null processing noise cancellation systems can determine a vector that indicates the direction of the source of an undesired component in an acoustic signal. This vector is referred to as a spatial “null” or “null vector.” Audio from the direction of the spatial null may be subsequently reduced. As the source of an undesired component in an acoustic signal moves relative to the position of the microphone(s), a noise reduction system can track the movement, and adapt and/or update the corresponding spatial null accordingly.

An example of a multi-microphone noise cancellation system which may perform null processing noise subtraction (NPNS) is described in U.S. Utility patent application Ser. No. 12/215,980, entitled “System and Method for Providing Noise Suppression Utilizing Null Processing Noise Subtraction,” filed Jun. 30, 2008, which is incorporated herein by reference. Noise subtraction systems can operate effectively in dynamic conditions and/or environments by continually interpreting the conditions and/or environment and adapting accordingly.

Information from the non-acoustic sensor 120 may be used to control the direction of a spatial null in the noise canceller 310. In particular, the non-acoustic sensor information may be used to direct a null in an NPNS module or a synthetic cardioid system based on positional information provided by the non-acoustic sensor 120. An example of a synthetic cardioid system is described in U.S. Utility patent application Ser. No. 11/699,732, entitled “System and Method for Utilizing Omni-Directional Microphones for Speech Enhancement,” filed Jan. 29, 2007, which is incorporated herein by reference.

In a two-microphone system, coefficients σ and α may have complex values. The coefficients may represent the transfer functions from a primary microphone signal (P) to a secondary (S) microphone signal in a two-microphone representation. However, the coefficients may also be used in an N microphone system. The goal of the σ coefficient(s) is to cancel the speech signal component captured by the primary microphone from the secondary microphone signal. The cancellation can be represented as S−σP. The output of this subtraction is an estimate of the noise in the acoustic environment. The α coefficient can be used to cancel the noise from the primary microphone signal using this noise estimate. Optimal σ and α coefficients can be derived using adaptation rules, wherein adaptation may be necessary to point the σ null in the direction of the speech source and the α null in the direction of the noise.

In adverse SNR conditions, it may become difficult to keep the system working optimally, i.e. optimally cancelling the noise and preserving the speech. In general, since speech cancellation is the most undesirable behavior, the system may be tuned in order to minimize speech loss. Even with the conservative tuning, noise leakage may occur.

As an alternative, a spatial map of the σ (and potentially α) coefficients can be created in the form of a table, comprising one set of coefficients per valid position. Each combination of coefficients may represent a position of the microphone(s) of the communication device relative to the MRP and/or a noise source. From the full set entailing all valid positions, an optimal set of values can be created, for example using the LBG algorithm. The size of the table may vary depending on the computation and memory resources available in the system. For example, the table could include u and a coefficients describing all possible positions of the phone around the head. The table could then be indexed using three-dimensional and proximity sensor data.

Still referring to FIG. 3, the analysis path sub-system 320 may include the feature extraction module 304, source interference engine module 306, and mask generator module 308. The feature extraction module 304 may receive the sub-band frame signals derived from the primary and secondary acoustic signals provided by the frequency analysis module 302. Furthermore, feature extraction module 304 may receive the output of NPNS module 310. The feature extraction module 304 may compute frame energy estimations of the sub-band signals, an inter-microphone level difference (ILD) between the primary acoustic signal and the secondary acoustic signal, and self-noise estimates for the primary and second microphones. The feature extraction module 504 may also compute other monaural or binaural features for processing by other modules, such as pitch estimates and cross-correlations between microphone signals. Furthermore, the feature extraction module 304 may provide inputs to and process outputs from the NPNS module 310, as indicated by a double-headed arrow in FIG. 3.

The feature extraction module 304 may compute energy levels for the sub-band signals of the primary and secondary acoustic signal and an inter-microphone level difference (ILD) from the energy levels. The ILD may be determined by feature extraction module 304. Determining energy level estimates and inter-microphone level differences is discussed in more detail in U.S. Utility patent application Ser. No. 11/343,524, entitled “System and Method for Utilizing Inter-Microphone Level Differences for Speech Enhancement”, which is incorporated herein by reference.

Non-acoustic sensor information may be used to configure a gain of a microphone signal as processed, for example by the feature extraction module 304. Specifically, in multi-microphone systems that use ILD as a source discrimination cue, the level of the main speech decreases as the distance from the primary microphone to the MRP increases. If the distance from all microphones to the MRP increases, the ILD of the main speech decreases, resulting in less discrimination between the main speech and the noise sources. Such corruption of the ILD cue may typically lead to undesirable speech loss. Increasing the gain of the primary microphone modifies the ILD in favor of the primary microphone. This results in less noise suppression but improves positional robustness.

The analysis path sub-system 320 may also include a source inference engine module 306, which may process frame energy estimates to compute noise estimates and which may derive models of the noise and speech from the sub-band signals. The frame energy estimate processed in module 306 may include the energy estimates of the output of the frequency analysis 302 and of the noise canceller 310. The source inference engine module 306 may adaptively estimate attributes of the acoustic sources. The energy estimates may be used in conjunction with speech models, noise models, and other attributes, estimated in module 306, to generate a multiplicative mask in mask generator module 308.

Still referring to FIG. 3, the source inference engine module 306 may receive the ILD from feature extraction module 304 and track the ILD-probability distributions or “clusters” of sound coming from a speech of the driver 110 and passenger 120, noise 130, and, optionally, echo. When the source and noise ILD-probability distributions are not overlapping, it is possible to specify a classification boundary or dominance threshold between the two distributions. The classification boundary or dominance threshold may be used to classify an audio signal as speech if the ILD is sufficiently positive or as noise if the ILD is sufficiently negative. The classification may be determined per sub-band and time frame and used to form a dominance mask as part of a cluster tracking process.

The classification may additionally be based on features extracted from one or more non-acoustic sensors 120 and, as a result, the audio processing system may exhibit improved positional robustness. The source interference engine module 306 may perform an analysis of sensor data 325, depending on which system parameters are intended to be modified based on the non-acoustic sensor data.

The source interference engine module 306 may provide the generated classification to the NPNS module 310, and may utilize the classification to estimate noise in NPNS output signals. A current noise estimate along with locations in the energy spectrum are provided for processing a noise signal within the audio processing system 210. Tracking clusters is described in U.S. Utility patent application Ser. No. 12/004,897, entitled “System and method for Adaptive Classification of Sound sources,” filed on Dec. 21, 2007, the disclosure of which is incorporated herein by reference.

The source inference engine module 306 may generate an ILD noise estimate and a stationary noise estimate. In one embodiment, the noise estimate can be combined with a max( ) operation, so that the noise suppression performance resulting from the combined noise estimate is at least that of the individual noise estimates. The ILD noise estimate can be derived from the dominance mask and the output of NPNS module 310.

For a given normalized ILD, sub-band, and non-acoustical sensor information, a corresponding equalization function may be applied to the normalized ILD signal to correct distortion. The equalization function may be applied to the normalized ILD signal by either the source inference engine 306 or mask generator 308.

The mask generator module 308 of the analysis path sub-system 320 may receive models of the sub-band speech components and/or noise components as estimated by the source inference engine module 306. Noise estimates of the noise spectrum for each sub-band signal may be subtracted from the energy estimate of the primary spectrum to infer a speech spectrum. The mask generator module 308 may determine a gain mask for the sub-band signals of the primary acoustic signal and provide the gain mask to the modifier module 312. The modifier module 312 can multiply the gain masks and the noise-subtracted sub-band signals of the primary acoustic signal output by the NPNS module 310, as indicated by the arrow from NPNS module 310 to the modifier module 312. Applying the mask reduces the energy levels of noise components in the sub-band signals of the primary acoustic signal and thus accomplishes noise reduction.

Values of the gain mask output from mask generator module 308 may be time-dependent and sub-band-signal-dependent, and may optimize noise reduction on a per sub-band basis. Noise reduction may be subject to the constraint that the speech loss distortion complies with a tolerable threshold limit. The threshold limit may be based on many factors. Noise reduction may be less than substantial when certain conditions, such as unacceptably high speech loss distortion, do not allow for more noise reduction. In various embodiments, the energy level of the noise component in the sub-band signal may be reduced to less than a residual noise target level. In some embodiments, the residual noise target level is substantially the same for each sub-band signal.

The reconstructor module 314 may convert the masked frequency sub-band signals from the cochlea domain back into the time domain. The conversion may include applying gains and phase shifts to the masked frequency sub-band signals adding the resulting signals. Once conversion to the time domain is completed, the synthesized acoustic signal may be provided to the user via the output device 206 and/or provided to a codec for encoding.

In some embodiments, additional post-processing of the synthesized time domain acoustic signal may be performed. For example, comfort noise generated by a comfort noise generator may be added to the synthesized acoustic signal prior to providing the signal to the user. Comfort noise may be a uniform constant noise that is not usually discernable by a listener (e.g., pink noise). This comfort noise may be added to the synthesized acoustic signal to enforce a threshold of audibility and to mask low-level non-stationary output noise components. In some embodiments, the comfort noise level may be chosen to be just above a threshold of audibility and/or may be settable by a user.

In some embodiments, noise may be reduced in acoustic signals received by the audio processing system 210 by a system that adapts over time. Audio processing system 210 may perform noise suppression and noise cancellation using initial values of parameters, which may be adapted over time based on information received from the non-acoustic sensor 120, acoustic signal processing, and a combination of non-acoustic sensor 120 information and acoustic signal processing.

Referring now to FIG. 4A, a placement of pair of broadside microphones on a roof of a vehicle is shown. FIG. 4B is a schematic top view of the FIG. 4A. According to an example embodiment, two microphones 106a and 106b may be placed on inner side of the roof 410 above the windshield of the automobile in front of a driver's seat 430 on left side from rear view mirror 420. The microphones 106a and 106b may be directed towards the driver. In some embodiments, the middle point between the microphones may lay within a plane 450 dividing the driver's seat 430 symmetrically and being perpendicular to the roof of the automobile. The microphones 106a and 106b may be located on a line perpendicular to the plane 450 and be symmetrical relative to the plane 450. In some embodiments, the distance between microphones 106a and 106b may be equal to 5 cm. (It should be appreciated that, though some examples describe the driver on the left side, in other embodiments, e.g., for certain countries, the driver's side and front passenger's sides may be reversed with corresponding relative arrangement of the microphones.)

In certain embodiments, a pair of microphones may be placed on the roof of automobile above a windshield in front of passenger seat 440 on right side of the rear view mirror 420 in a similar manner.

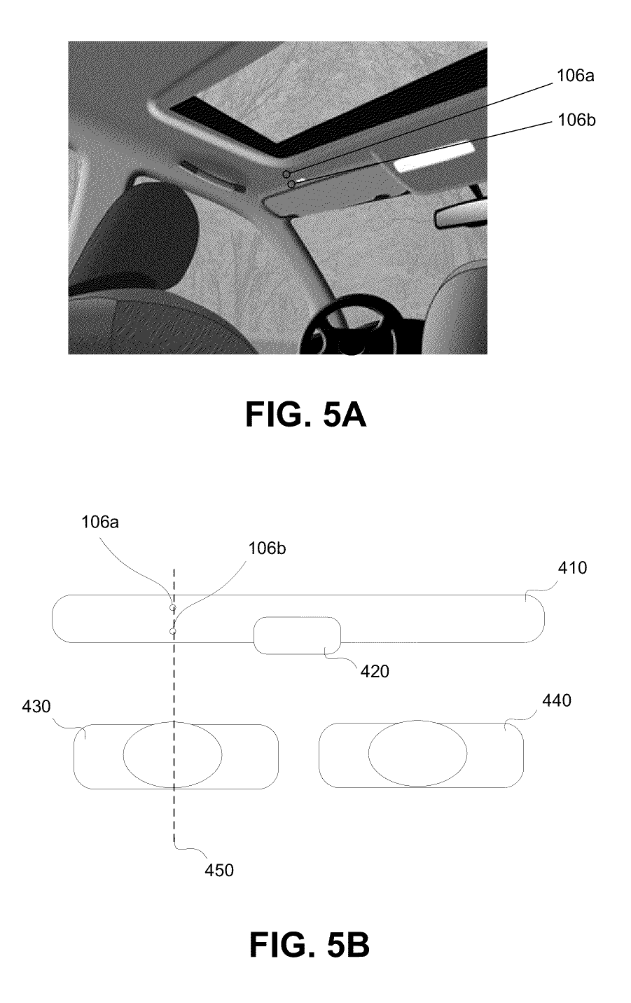

FIG. 5A shows an example placement of pair of front/back microphones on a roof of automobile. FIG. 5B is a schematic top view of the FIG. 5A. According to an example embodiment, two microphones 106a and 106b may be placed on inner side of the roof 410 above the windshield of the automobile in front of a driver's seat 430 on left side from the rear view mirror 420. The microphones 106a and 106b may be directed towards the driver. In some embodiments, the microphones may be located in the plane 450 dividing the driver's seat 430 symmetrically and perpendicular to the roof of the automobile. In some embodiments, a pair of front/back microphones may be placed on the inner side of roof 410 above the windshield on the left side from the rear view mirror 420 in front of the passenger seat 440.

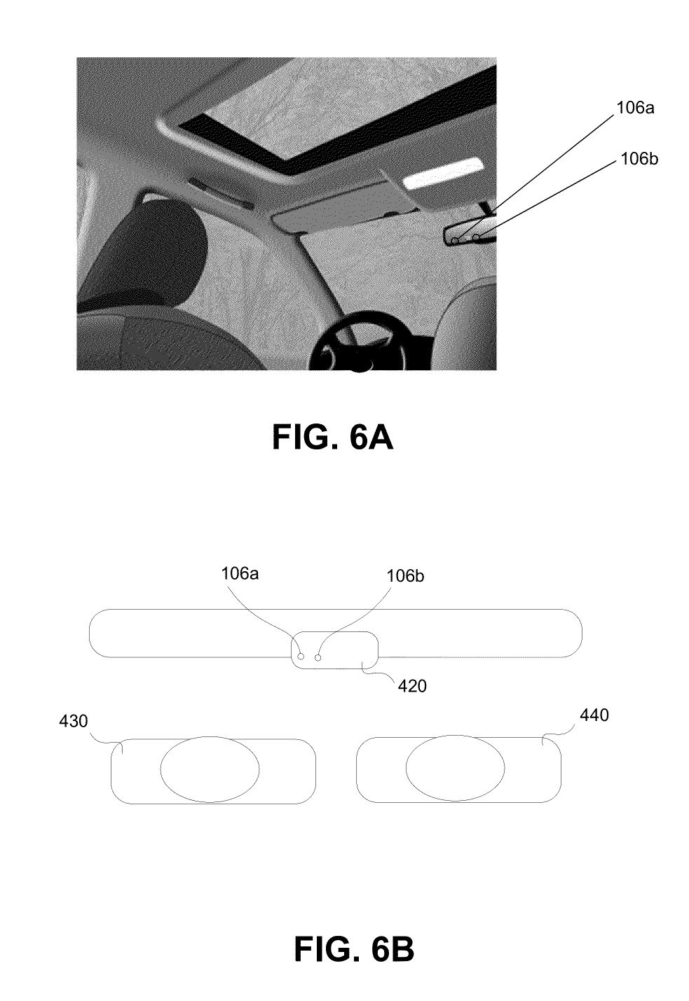

FIG. 6A shows an example of placement of pair of front/back microphones on a rear view mirror of automobile. FIG. 6B is a schematic top view of the FIG. 6A. In some embodiments, the microphones 106a and 106b may be placed in the left bottom corner of the rear view mirror 420 and directed towards the driver's seat. In certain embodiments, a pair of microphones may be placed in the right bottom corner of the rear view mirror 420 and directed towards to the passenger's seat 440.

In further embodiments, two microphones may be disposed on a driver's and/or a passenger's sun visor. Since a sun visor may be oriented or configured in different positions, a non-acoustic sensor (e.g., accelerometer, gyroscope, proximity sensor, level sensor, light sensor, and the like) may also be disposed in, on, and/or about the sun visor. An example use of non-acoustic sensor information in noise reduction systems is described in U.S. patent application Ser. No. 13/529,809, entitled “Selection of System Parameters Based on Non-Acoustic Sensor Information,” filed on Jun. 21, 2012, which is incorporated herein by reference in its entirety.

In further embodiments, two or more microphones may be directed toward the speaker (e.g., driver, front passenger, and back-seat passenger(s)) and located relatively close to the speaker. Two or more microphones may also be directed towards a speaker but not in close proximity of the speaker (e.g., microphones located toward the front of the vehicle and directed to a speaker(s) towards the rear of the vehicle). In some embodiments, an acceptable positional region (e.g., cone of selectivity) for a speech source may be defined. For example, the cone of selectivity may define a region of interest in the acoustic environment of the vehicle and an acoustic source within the cone of selectivity may be classified as speech. An example of defining an acceptable positional region in noise reduction systems is disclosed in U.S. patent application Ser. No. 12/906,009, entitled “Multi-Microphone Acoustic Processing System,” filed on Oct. 15, 2012, which is incorporated herein by reference in its entirety.

In some embodiments, different vehicle occupants (e.g., driver, front seat passenger, rear seat passenger(s)) may have microphones directed towards them or their approximate location within the acoustic environment of the vehicle. When a certain speaker is speaking, the acoustic signals from microphones directed towards other vehicle occupants may be used to reduce noise originating from other vehicle occupants. In some embodiments, two or more microphones may be directed towards the speaker. In further embodiments, two or more microphones may be positioned in relatively close proximity to each other.

In some embodiments, multiple occupants of the vehicle may participate in communications with parties outside the vehicle (e.g., via a communications network over a mobile telephone, telematics device such as OnStar, and the like). For example, communications with multiple occupants of the vehicle can be similar to a conference call or multi-way call (in the noisy environment of the vehicle) where each vehicle occupant may be clearly heard and understood by the party or parties outside of the vehicle. Likewise, occupants may hear the other participants of the call, for example, through the vehicle's audio system (e.g., car stereo, entertainment system, headphones, public address system, and so forth).

Noise within the vehicle may also interfere with communications within the vehicle, for example, between the occupants of the front seats (e.g., driver) and occupants of the rear seats (e.g., back seat, third-row seats, and so forth). In further embodiments of the present technology, persons located within the vehicle (e.g., in the front seat, rear seat, third-row seat, and so forth) may communicate with each other despite the noise. For example, speech from a vehicle occupant may be detected by at least some of the microphones and provided to the other vehicle occupant(s) over the vehicle's audio system.

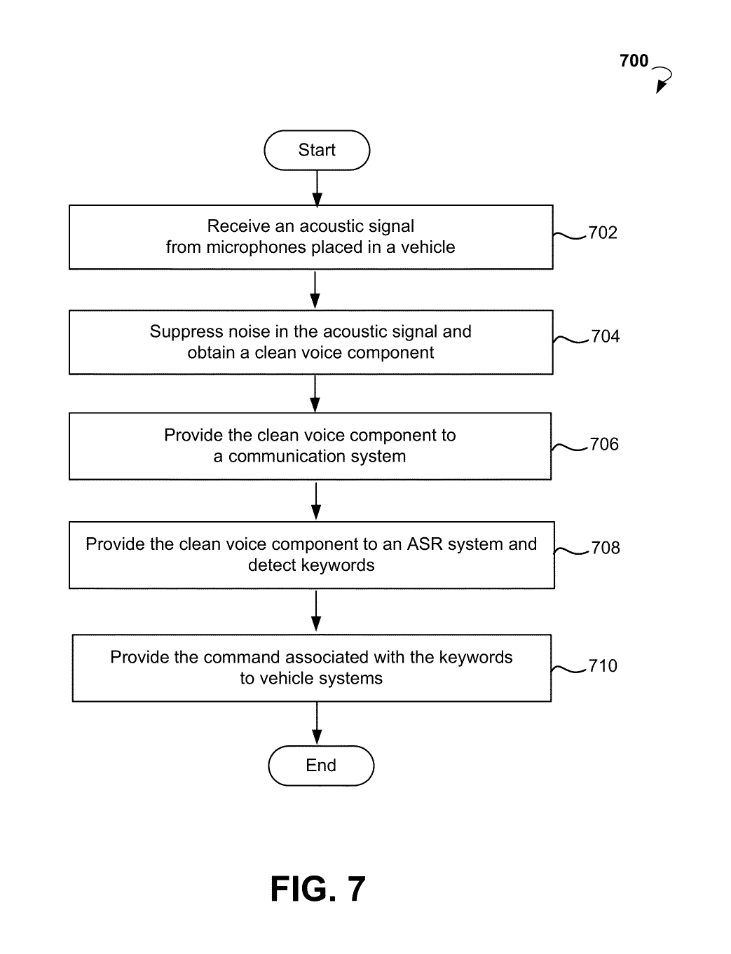

Referring now to FIG. 7, an example method 700 for processing an acoustic signal in automobiles is shown. The method 700 may commence with receiving an acoustic signal by microphones placed in automobile at step 702. In step 704, noise may be suppressed from the acoustic signal to obtain a clean voice component. The clean voice component may be provided to a communication system at step 706. The clean voice component may be provided to an automatic speech recognition (ASR) system. e.g., to detect keywords, etc., at step 708. In step 710, the ASR system may provide the command associated with detected keywords to the corresponding vehicle systems.

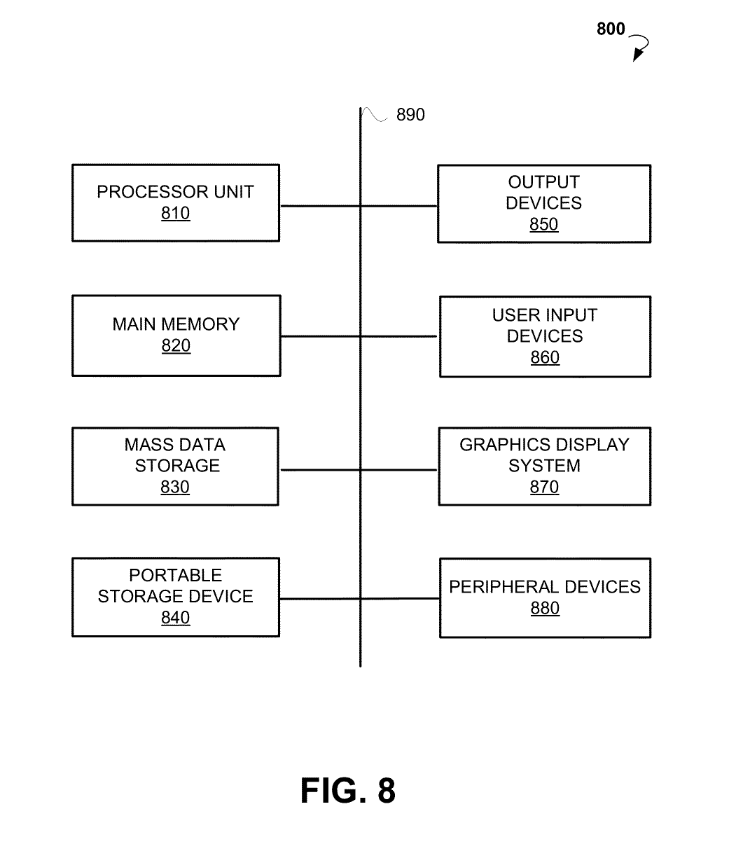

FIG. 8 illustrates an example computing system 800 that may be used to implement embodiments of the present disclosure. The system 800 of FIG. 8 may be implemented in the contexts of the likes of computing systems, networks, servers, or combinations thereof. The computing system 800 of FIG. 8 includes one or more processors 810 and main memory 820. Main memory 820 stores, in part, instructions and data for execution by processor 810. Main memory 820 may store the executable code when in operation. The system 800 of FIG. 8 further includes a mass storage device 830, portable storage medium drive(s) 840, output devices 850, user input devices 860, a graphics display 870, and peripheral devices 880.

The components shown in FIG. 8 are depicted as being connected via a single bus 890. The components may be connected through one or more data transport means. Processor 810 and main memory 820 may be connected via a local microprocessor bus, and the mass storage device 830, peripheral device(s) 880, portable storage device 840, and display system 870 may be connected via one or more input/output (I/O) buses.

Mass storage device 830, which may be implemented with a magnetic disk drive or an optical disk drive, is a non-volatile storage device for storing data and instructions for use by processor unit 810. Mass storage device 830 may store the system software for implementing embodiments of the present disclosure for purposes of loading that software into main memory 820.

Portable storage device 840 operates in conjunction with a portable non-volatile storage medium, such as a floppy disk, compact disk, digital video disc, or Universal Serial Bus (USB) storage device, to input and output data and code to and from the computer system 800 of FIG. 8. The system software for implementing embodiments of the present disclosure may be stored on such a portable medium and input to the computer system 800 via the portable storage device 840.

Input devices 860 provide a portion of a user interface. Input devices 860 may include one or more microphones, an alphanumeric keypad, such as a keyboard, for inputting alphanumeric and other information, or a pointing device, such as a mouse, a trackball, stylus, or cursor direction keys. Input devices 860 may also include a touchscreen. Additionally, the system 800 as shown in FIG. 8 includes output devices 850. Suitable output devices include speakers, printers, network interfaces, and monitors.

Display system 870 may include a liquid crystal display (LCD) or other suitable display device. Display system 870 receives textual and graphical information and processes the information for output to the display device.

Peripheral devices 880 may include any type of computer support device to add additional functionality to the computer system.

The components provided in the computer system 800 of FIG. 8 are those typically found in computer systems that may be suitable for use with embodiments of the present disclosure and are intended to represent a broad category of such computer components that are well known in the art. Thus, the computer system 800 of FIG. 8 may be a personal computer (PC), hand held computing system, telephone, mobile computing system, workstation, server, minicomputer, mainframe computer, or any other computing system. The computer may also include different bus configurations, networked platforms, multi-processor platforms, and the like. Various operating systems may be used including UNIX, LINUX, WINDOWS, PALM OS, CHROME, ANDROID, MAC OS, IOS, and other suitable operating systems.

It is noteworthy that any hardware platform suitable for performing the processing described herein is suitable for use with the embodiments provided herein. Computer-readable storage media refer to any medium or media that participate in providing instructions to a central processing unit (CPU), a processor, a microcontroller, or the like. Such media may take forms including, but not limited to, non-volatile and volatile media such as optical or magnetic disks and dynamic memory, respectively. Common forms of computer-readable storage media include a floppy disk, a flexible disk, a hard disk, magnetic tape, any other magnetic storage medium, a Compact Disk Read Only Memory (CD-ROM) disk, digital video disk (DVD), BLU-RAY DISC (BD), any other optical storage medium, Random-Access Memory (RAM), Programmable Read-Only Memory (PROM), Erasable Programmable Read-Only Memory (EPROM), Electronically Erasable Programmable Read Only Memory (EEPROM), flash memory, and/or any other memory chip, module, or cartridge.

In some embodiments, the computing system 800 may be implemented as a cloud-based computing environment, such as a virtual machine operating within a computing cloud. In other embodiments, the computing system 800 may itself include a cloud-based computing environment, where the functionalities of the computing system 800 are executed in a distributed fashion. Thus, the computing system 800, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud may be formed, for example, by a network of web servers that comprise a plurality of computing devices, with each server (or at least a plurality thereof) providing processor and/or storage resources. These servers may manage workloads provided by multiple users (e.g., cloud resource customers or other users). Typically, each user places workload demands upon the cloud that vary in real-time, sometimes dramatically. The nature and extent of these variations typically depends on the type of business associated with the user.

While the present embodiments have been described in connection with a series of embodiments, these descriptions are not intended to limit the scope of the subject matter to the particular forms set forth herein. It will be further understood that the methods are not necessarily limited to the discrete components described. To the contrary, the present descriptions are intended to cover such alternatives, modifications, and equivalents as may be included within the spirit and scope of the subject matter as disclosed herein and defined by the appended claims and otherwise appreciated by one of ordinary skill.

What is claimed is:

1. A system for processing an acoustic signal in a vehicle, the system comprising
one or more microphones; and
a voice monitoring device, the voice monitoring device being configured to:
receive, via the one or more microphones, the acoustic signal;
suppress noise in the acoustic signal to obtain a clean speech component; and
provide the clean speech component to one or more vehicle systems.

2. The system of claim 1, wherein two microphones selected from the one or more microphones are positioned on an inner side of a roof of the vehicle, above a windshield, in front of a driver's seat, and directed towards a driver.

3. The system of claim 2, wherein the selected two microphones are equally spaced relative to a symmetry plane of the driver's seat.

4. The system of claim 3, wherein the distance between the selected two microphones is about 5 cm.

5. The system of claim 1, wherein at least one microphone selected from the one or more microphones is configured to receive only noise.

6. The system of claim 1, wherein at least one microphone selected from the one or more microphones is configured to receive at least mostly speech.

7. The system of claim 1, wherein the voice monitoring device is further configured to provide the clean speech component to a communication system, the communication system being configured to provide the clean speech component to a device located outside the vehicle via a communications network.

8. The system of claim 1, wherein the voice monitoring device is further configured to provide the clean speech component to a communication system, the communication system being configured to provide the clean speech component to one or more persons located inside the vehicle.

9. The system of claim 1, wherein the voice monitoring device is further configured to suppress speech signals originating from a source outside a pre-determined area in the vehicle.

10. A method for processing an acoustic signal in a vehicle, the method comprising:
receiving, via the one or more microphones, the acoustic signal;
suppressing noise in the acoustic signal to obtain a clean speech component; and
providing the clean speech component to one or more vehicle systems.

11. The method of claim 10, wherein two microphones selected from the one or more microphones are positioned on an inner side of a roof of the vehicle, above a windshield, in front of a driver's seat, and directed towards a driver.

12. The method of claim 11, wherein the selected two microphones are equally spaced relative to a symmetry plane of the driver's seat.

13. The method of claim 12, wherein the distance between the selected two microphones is about 5 cm.

14. The method of claim 10, wherein at least one microphone selected from the one or more microphones is configured to receive only noise.

15. The method of claim 10, wherein at least on microphone selected from the one or more microphones is configured to receive at least mostly speech.

16. The method of claim 10, further comprising providing the clean speech component to a communication system, the communication system being configured to provide the clean speech component to a device located outside the vehicle vehicle via a communications network.

17. The method of claim 10, further comprising providing the clean speech component to a communication system, the communication system being configured to provide the clean speech component to one or more persons located inside vehicle.

18. The system of claim 1, further comprising suppressing speech signals originating from a source outside at least one pre-determined area in the vehicle.

19. A non-transitory machine readable medium having embodied thereon a program, the program providing instructions for a method for processing an acoustic signal in vehicle, the method comprising:
receiving, via the one or more microphones, the acoustic signal, the acoustic signal including speech and noise;
suppressing noise in the acoustic signal to obtain a clean speech component; and
providing the clean speech component to one or more vehicle systems.

20. The non-transitory machine readable medium of claim 19, wherein two microphones selected from the one or more microphones:
are placed on an inner side of a roof of the vehicle, above a windshield, in front of a driver's seat, and directed towards a driver; and
are equally spaced relative to a symmetry plane of the driver's seat.
